(19) United States
(12) Patent Application Publication
(10) Pub. No.: US 2009/0184896 A1
(43) Pub. Date: Jul. 23, 2009

(54) ORGANIC LIGHT EMITTING DISPLAY AND METHOD OF DRIVING THE SAME

(75) Inventor: Oh-Kyong KWON, Seoul (KR)

Correspondence Address: STEIN MCEWEN, LLP, 1400 EYE STREET, NW, SUITE 300, WASHINGTON, DC, 20005, US

(73) Assignees: Samsung SDI Co., Ltd., Suwon-si (KR); IUCF-HYU, Seongdong-gu (KR)

(21) Appl. No.: 12/169,089

(22) Filed: Jul. 8, 2008

(30) Foreign Application Priority Data
Jan. 21, 2008 (KR) 2008-6143

(51) Int. Cl. G09G 3/30

(52) U.S. Cl. 345/76

(57) ABSTRACT

There is provided an organic light emitting display capable of compensating for the deterioration of organic light emitting diodes (OLED) while sharing an analog-to-digital converter (ADC). The organic light emitting display includes sub pixels positioned in the intersections between scan lines and data lines, a current source unit for supplying predetermined current to organic light emitting diodes (OLED) in a sensing period for grasping deterioration information on the OLEDs included in the sub pixels, at least one analog-to-digital converter (ADC) provided fewer than data lines in order to convert a voltage applied to the OLEDs into a digital signal, and a switching unit for coupling the data lines to the current source unit in the sensing period and for sequentially coupling at least one ADC to the data lines in the sensing period.

### CROSS-REFERENCE TO RELATED APPLICATIONS

This application claims priority to and the benefit of Korean Patent Application No. 2008-6143, filed on Jan. 21, 2008, in the Korean Intellectual Property Office, the entire content of which is incorporated herein by reference.

### BACKGROUND OF THE INVENTION

1. Field of the Invention

The present invention relates to an organic light emitting display and a method of driving the same, and more particularly, to an organic light emitting display capable of compensating for the deterioration of an organic light emitting diode (OLED) while sharing an analog-to-digital converter (ADC) and a method of driving the same.

2. Description of the Related Art

Recently, various flat panel displays (FPD) capable of reducing weight and volume that are disadvantageous in cathode ray tubes (CRT) have been developed. The FPDs include liquid crystal displays (LCD), field emission displays (FED), plasma display panels (PDP), and organic light emitting displays.

Among the FPDs, the organic light emitting displays display images using organic light emitting diodes (OLED) that generate light by re-combination of electrons and holes. The organic light emitting display has high response speed and is driven with low power consumption.

In general, the organic light emitting display displays a desired image while supplying current corresponding to gray scales to organic light emitting diodes (OLED) arranged in pixels. However, the OLEDs deteriorate with the lapse of time so that an image of desired brightness cannot be displayed. Actually, when the OLEDs deteriorate, light with low brightness is gradually generated to correspond to the same data signals.

In order to solve these problems, various systems capable of compensating for the deterioration of the OLEDs have been proposed. In conventional systems, a predetermined current is supplied to the OLEDs and deterioration information on the OLEDs is determined by using a voltage applied to the OLEDs when the predetermined current is supplied.

Here, according to a conventional invention, in order to convert the voltage applied to the OLEDs, an analog-to-digital converter (ADC) is provided in each channel. However, when the ADC is provided in each channel, the volume of an integrated circuit (IC) increases and manufacturing cost increases.

### SUMMARY OF THE INVENTION

Accordingly, it is an object of the present invention to provide an organic light emitting display capable of compensating for the deterioration of organic light emitting diodes (OLED) while sharing an analog-to-digital converter (ADC) and a method of driving the same.

In order to achieve the foregoing and/or other objects of the present invention, an organic light emitting display according to an embodiment of the present invention includes sub pixels positioned in the intersections between scan lines and data lines, a current source unit for supplying predetermined current to organic light emitting diodes (OLED) in a sensing period for grasping deterioration information on the OLEDs included in the sub pixels, at least one analog-to-digital converter (ADC) provided fewer than data lines in order to convert a voltage applied to the OLEDs into a digital signal, and a switching unit for coupling the data lines to the current source unit in the sensing period and for sequentially coupling at least one ADC to the data lines in the sensing period.

At least one ADC comprises a first analog-to-digital converter (ADC) for converting a voltage of OLEDs included in red sub pixels into a digital signal, a second ADC for converting a voltage of OLEDs included in green sub pixels into a digital signal, and a third ADC for converting a voltage of OLEDs included in blue sub pixels into a digital signal.

The organic light emitting display further comprises a deterioration compensating unit for controlling digital signals supplied from the first to third ADCs to compensate for deterioration of the OLEDs, a timing controller for changing a bit value of data so that the deterioration can be compensated for by the control of the deterioration compensating unit, a data driver for converting data supplied from the timing controller into data signals to supply the data signals to the data lines, a scan driver for supplying scan signals to the scan lines and for supplying control signals to control lines that run parallel to the scan lines.

The scan driver turns on transistors positioned between the data lines and the OLEDs in the sub pixels while sequentially supplying the control signals to the control lines in the sensing period.

The organic light emitting display further comprises fourth switches formed between the current source unit and the data lines, fifth switches formed between the data driver and the data lines, first switches positioned between the data lines coupled to the red sub pixels and the first ADC, second switches positioned between the data lines coupled to the green sub pixels and the second ADC, and third switches positioned between data lines coupled to the blue sub pixels and the third ADC.

The fourth switches are maintained to be turned on in the sensing period and the fifth switches are maintained to be turned on in a driving period where an image is displayed on the sub pixels. The first switches, the second switches, and the third switches are sequentially turned on when the control signals are supplied. The red sub pixels, the green sub pixels, and the blue sub pixels constitute a pixel and first switches, second switches, and third switches coupled to the same pixel are simultaneously turned on. The current source unit comprises at least one current source for supplying the current.

A method of driving an organic light emitting display comprises supplying predetermined current to OLEDs included in sub pixels in units of horizontal lines in a sensing period, converting a voltage applied to the OLEDs to correspond to the predetermined current into a digital signal while sharing at least one ADC, changing a bit value of data to compensate for deterioration of the OLEDs to correspond to the digital signal, and generating data signals using the data in a driving period and supplying the data signals to the sub pixels.

In converting a voltage applied to the OLEDs to correspond to the predetermined current into a digital signal while sharing at least one ADC, the digital signals are generated while sequentially coupling a first ADC to red sub pixels, a second ADC to green sub pixels, and a third ADC to blue sub pixels. The red sub pixels, the green sub pixels, and the blue sub pixels constitute one pixel and the red sub pixels, the green sub pixels, and the blue sub pixels that constitute the same pixel are simultaneously coupled to the first ADC, the second ADC, and the third ADC.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 illustrates an organic light emitting display according to an embodiment of the present invention;

FIG. 2 illustrates a current source unit and a switching unit of FIG. 1;

FIG. 3 is a circuit diagram illustrating pixels of FIG. 1;

FIG. 4 illustrates waveforms illustrating the operation processes of switches of FIG. 2; and

FIGS. 5A to 5E illustrate the operation processes of the switches corresponding to the waveforms of FIG. 4.

### DETAILED DESCRIPTION OF THE EMBODIMENTS

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

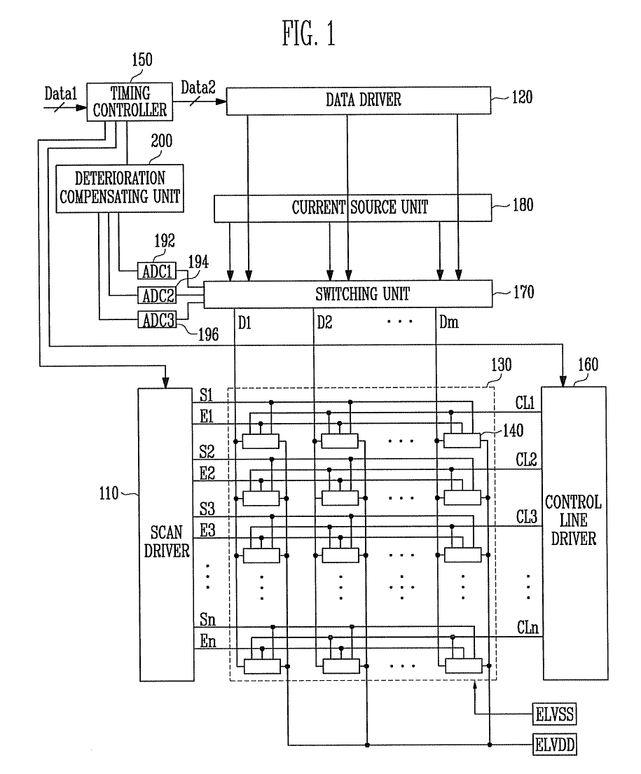

Hereinafter, exemplary embodiments through which those skilled in the art can easily perform the present invention will be described in detail with reference to FIGS. 1 to 5E.

FIG. 1 illustrates an organic light emitting display according to an embodiment of the present invention.

Referring to FIG. 1, the organic light emitting display according to an embodiment of the present invention includes a pixel unit 130, a scan driver 110, a control line driver 160, a data driver 120, and a timing controller 150.

In addition, the organic light emitting display according to an embodiment of the present invention further includes analog-to-digital converters (ADC) 192, 194, and 196, a current source unit 180, a switching unit 170, and a deterioration compensating unit 200.

The pixel unit 130 includes sub-pixels 140 positioned in the intersections of scan lines S1 to Sn, emission control lines E1 to En, control lines CL1 to CLn, and data lines D1 to Dm. The sub pixels 140 receive a first power source ELVDD and a second power source ELVSS from the outside. The sub pixels 140 control the amount of current supplied from the first power source ELVDD to the second power source ELVSS via organic light emitting diodes (OLED) in response to data signals. Then, light with predetermined brightness is generated by the OLEDs.

The control line driver 160 sequentially supplies control signals to the control lines CL1 to CLn by the control of the timing controller 150 to drive the control lines CL1 to CLn. Here, the control line driver 160 supplies the control signals while predetermined current is supplied from the current source unit 180 to the sub pixels 140.

The scan driver 110 sequentially supplies scan signals to the scan lines S1 to Sn by the control of the timing controller 150 in a driving period. In addition, the scan driver 110 supplies emission control signals to the emission control lines E1 to En by the control of the timing controller 150. In such a method, the scan driver 110 drives the scan lines S1 to Sn and the emission control lines E1 to En.

The data driver 120 supplies the data signals to data lines D1 to Dm by the control of the timing controller 150 in the driving period. Therefore, the data driver 120 drives the data lines D1 to Dm. The switching unit 170 controls coupling the current source unit 180, the data driver 120, and the ADCs 192, 194, and 196 with the data lines D1 to Dm. To be specific, the switching unit 170 couples the current source unit 180 to the data lines D1 to Dm in a sensing period. Then, the switching unit 170 sequentially couples the ADCs 192, 194, and 196 to the data lines D1 to Dm in the sensing period. On the other hand, the switching unit 170 couples the data lines D1 to Dm to the data driver 120 in the driving period.

The current source unit 180 supplies predetermined current to the sub pixels 140 via the data lines D1 to Dm in the sensing period. To be specific, the current source unit 180 supplies predetermined current to the data lines D1 to Dm in the sensing period. At this time, the sub pixels 140 are sequentially selected by the control signals in units of horizontal lines so that predetermined current is supplied to the OLEDs included in the sub pixels 140. In this case, a voltage corresponding to the predetermined current is applied to the OLEDs.

On the other hand, the value of the predetermined current supplied from the current source unit 180 is experimentally determined so that a sufficient voltage is applied to the OLEDs. For example, the current source unit 180 can supply current corresponding to the brightest gray level to the OLEDs.

The ADCs 192, 194, and 196 convert the voltage applied to the OLEDs of the sub pixels 140 into a digital signal.

To be specific, the first ADC 192 is sequentially coupled to the red sub pixels 140 by the control of the switching unit 170 in the sensing period. The first ADC 192 converts the voltage applied to the OLEDs of the red sub pixels 140 into the digital signal to supply the digital signal to the deterioration compensating unit 200.

The second ADC 194 is sequentially coupled to the green sub pixels 140 by the control of the switching unit 170 in the sensing period. The second ADC 194 converts the voltage applied to the OLEDs of the green sub pixels 140 into the digital signal to supply the digital signal to the deterioration compensating unit 200.

The third ADC 196 is sequentially coupled to the blue sub pixels 140 by the control of the switching unit 170 in the sensing period. The third ADC 196 converts the voltage applied to the OLEDs of the green sub pixels 140 into the digital signal to supply the digital signal to the deterioration compensating unit 200.

The deterioration compensating unit 200 compensates for the deterioration of the OLEDs using the digital signal supplied from the ADCs 192,194, and 196. To be specific, the deterioration compensating unit 200 controls the timing controller 150 to compensate for the deterioration of the OLEDs included in the sub pixels 140 using the digital signal supplied from the ADCs 192, 194, and 196. Here, the deterioration compensating unit 200 includes structures disclosed in applications previously filed or currently published by the applicant. Since the ADCs 192, 194, and 196 are shared according to the present invention, the detailed structure and description of the deterioration compensating unit 200 will be omitted.

The timing controller 150 controls the data driver 120, the scan driver 110, and the control line driver 160. In addition, the timing controller 150 converts the bit value of first data Data1 input from the outside into second data Data2 so that the deterioration can be compensated for by the control of the deterioration compensating unit 200. Here, the first data Data1 is set as i (i is a natural number) bits and the second data Data2 is set as j (j is a natural number no less than i) bits.

The second data Data2 generated by the timing controller 150 is supplied to the data driver 120. Then, the data driver 120 generates the data signals using the second data Data2 and supplies the generated data signals to the sub pixels 140.

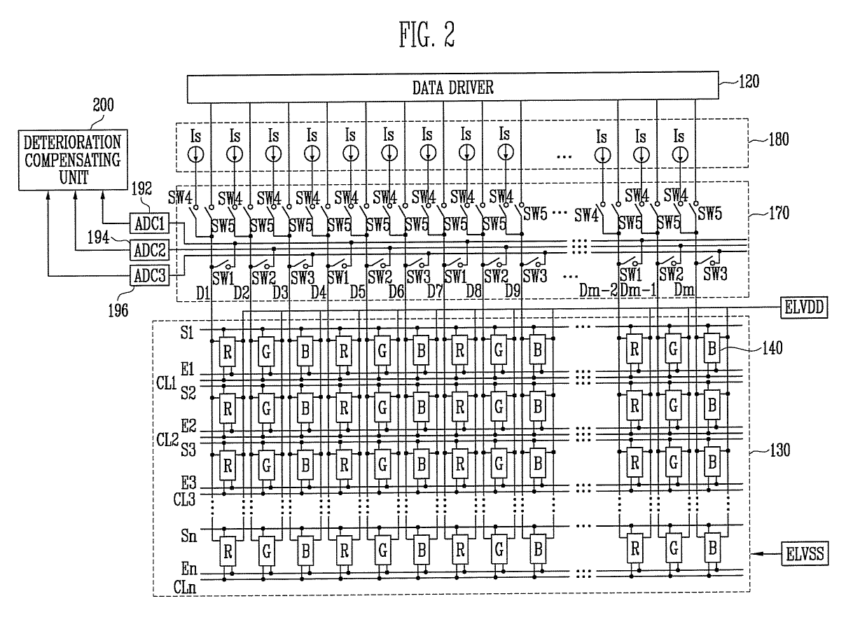

FIG. 2 illustrates the current source unit and the switching unit of FIG. 1.

Referring to FIG. 2, the current source unit 180 according to the present invention includes current sources Is formed in channels.

The current sources Is supplies predetermined current to the data lines D1 to Dm in the sensing period. The predetermined current supplied to the data lines D1 to Dm is supplied to the sub pixels 140 selected by the control signals. In this case, a voltage corresponding to the predetermined current is applied to the OLEDs included in the sub pixels 140.

On the other hand, in FIG. 2, it was described that the current sources Is are provided in the channels. However, the present invention is not limited to the above. For example, one current source Is can be coupled to all of the fourth switches SW4.

In addition, current sources for supplying current to the red sub pixels R, the green sub pixels G, and the blue sub pixels B can vary. To be specific, the OLEDs included in the red sub pixels R, the green sub pixels G, and the blue sub pixels B are formed of different materials. Therefore, the current sources for supplying current to the red sub pixels R, the green sub pixels G, and the blue sub pixels B can vary to supply different currents in consideration of the characteristics of the OLEDs included in the sub pixels R, G, and B.

The switching unit 170 includes fourth switches SW4 and fifth switches SW5 and first to third switches SW1 to SW3 formed in the channels. Here, the first switches SW1, the second switches SW2, and the third switches SW3 are formed to be coupled to the data lines D1, D4, . . . coupled to the red sub pixels R, the data lines D2, D5, . . . coupled to the green sub pixels G, and the data lines D3, D6, . . . coupled to the blue sub pixels B.

The fourth switches SW4 are positioned between the current sources Is and the data lines D. The fourth switches SW4 are turned on in the sensing period. Here, the sensing period is a period in which the deterioration of the OLEDs included in the sub pixels 140 is measured and is provided in various points of time by a designer. For example, the sensing period can be positioned at the point of time where a power source is supplied to the organic light emitting display.

The fifth switches SW5 are positioned between the data driver 120 and the data lines D. The fifth switches SW5 are turned on in the driving period. Here, the driving period is a period in which a predetermined image is displayed by the sub pixels 140 excluding the sensing period.

The first switches SW1 are formed between the data lines D1, D4, . . . coupled to the red sub pixels R and the first ADC 192. The first switches SW1 are sequentially turned on whenever the control signals are supplied to the control lines CL1 to CLn.

The second switches SW2 are formed between the data lines D2, D5, . . . and the second ADC 194. The Second switches SW2 are sequentially turned on whenever the control signals are supplied to the control lines CL1 to CLn.

The third switches SW3 are formed between the data lines D3, D6, . . . coupled to the blue sub pixels B and the third ADC 196. The third switches SW3 are sequentially turned on whenever the control signals are supplied to the control lines CL1 to CLn.

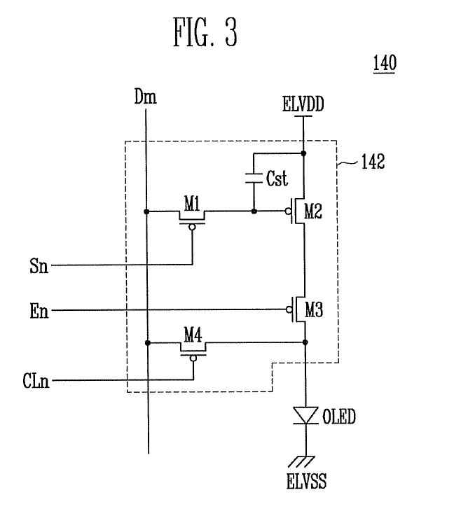

FIG. 3 illustrates a sub pixel according to an embodiment of the present invention. In FIG. 3, for convenience sake, the pixel coupled to the mth data line Dm and the nth scan line Sn is illustrated.

Referring to FIG. 3, the sub pixel 140 according to an embodiment of the present invention includes an OLED and a pixel circuit 142 for supplying current to the OLED.

The anode electrode of the OLED is coupled to the pixel circuit 142 and the cathode electrode of the OLED is coupled to the second power source ELVSS. The OLED generates light with predetermined brightness in response to the current supplied from the pixel circuit 142.

The pixel circuit 142 receives the data signal from the data line Dm when the scan signal is supplied to the scan line Sn. In addition, the pixel circuit 142 receives predetermined current from the current source unit 180 when the control signal is supplied to the control line CLn and supplies a voltage corresponding to the received current to the third ADC 196. Therefore, the pixel circuit 142 includes four transistors M1 to M4 and a storage capacitor Cst.

The gate electrode of the first transistor M1 is coupled to the scan line Sn and the first electrode of the first transistor M1 is coupled to the data line Dm. Then, the second electrode of the first transistor M1 is coupled to the first terminal of a storage capacitor Cst. The first transistor M1 is turned on when the scan signal is supplied to the scan line Sn. Here, the scan signal is supplied while a voltage corresponding to the data signal is charged in the storage capacitor Cst.

The gate electrode of the second transistor M2 is coupled to the first terminal of the storage capacitor Cst and the first electrode of the second transistor M2 is coupled to the second terminal of the storage capacitor Cst and the first power source ELVDD. The second transistor M2 controls the amount of current that flows from the first power source ELVDD to the second power source ELVSS via the OLED to correspond to the value of the voltage stored in the storage capacitor Cst. At this time, the OLED generates light corresponding to the amount of current supplied from the second transistor M2.

The gate electrode of the third transistor M3 is coupled to the emission control line En and the first electrode of the third transistor M3 is coupled to the second electrode of the second transistor M2. Then, the second electrode of the third transistor M3 is coupled to the OLED. The third transistor M3 is turned off when the emission control signal is supplied to the emission control line En and is turned on when the emission control signal is not supplied. Here, the emission control signal is supplied in a period where the voltage corresponding to the data signal is charged in the storage capacitor Cst and in the sensing period where deterioration information on the OLED is sensed.

The gate electrode of the fourth transistor M4 is coupled to the control line CLn and the first electrode of the fourth transistor M4 is coupled to the second electrode of the third transistor M3. In addition, the second electrode of the fourth transistor M4 is coupled to the data line Dm. The fourth transistor M4 is turned on when the control signal is supplied to the control line CLn and is turned off in the other cases. Here, the control signals supplied to the control lines CL1 to CLn are sequentially supplied in the sensing period.

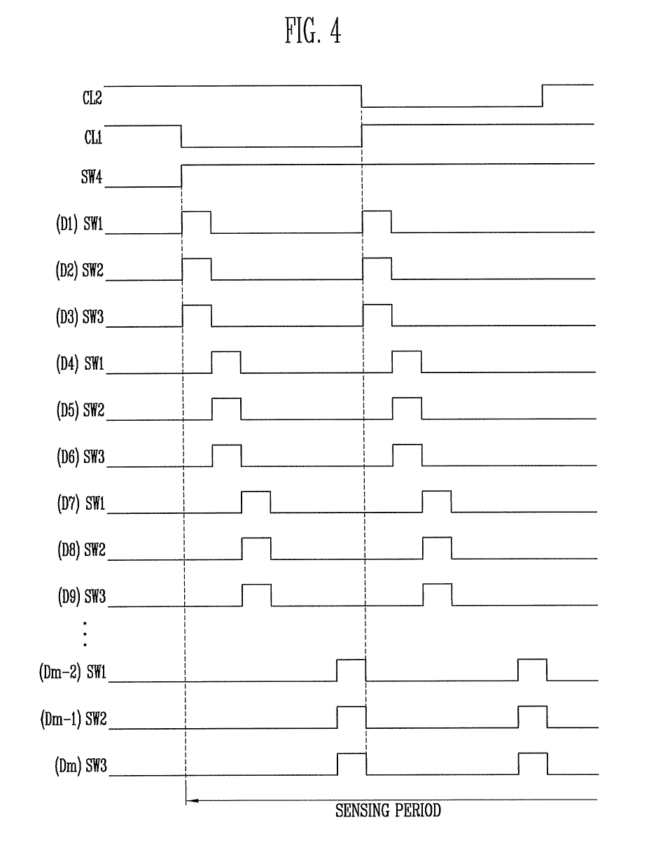

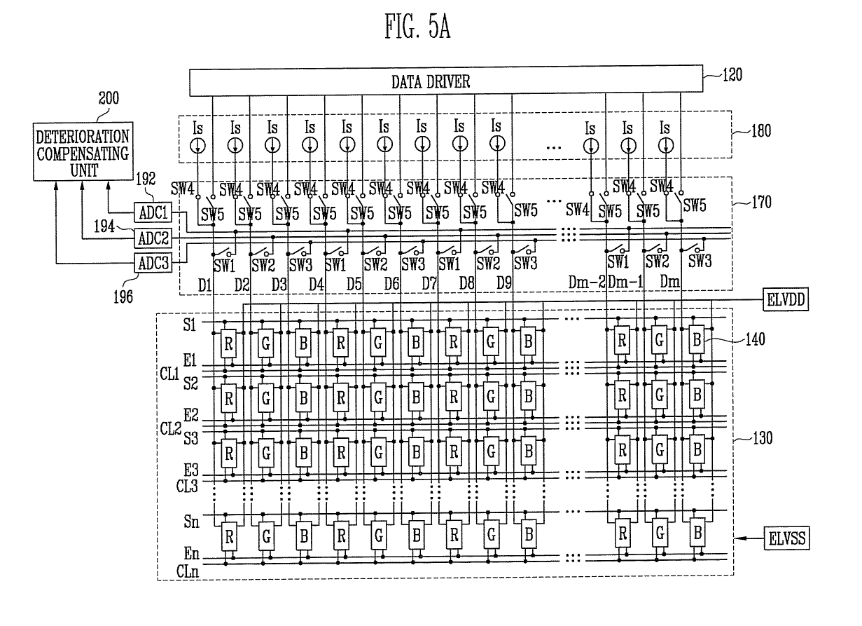

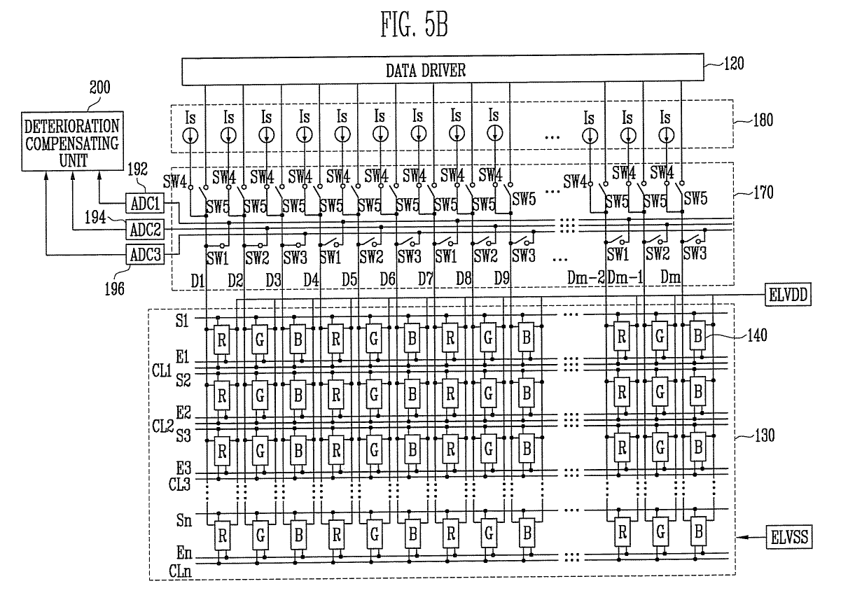

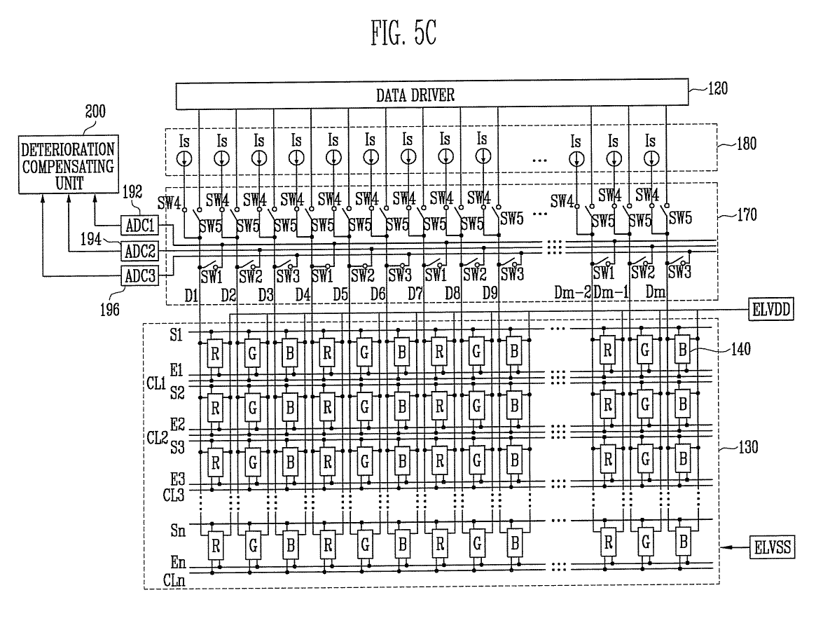

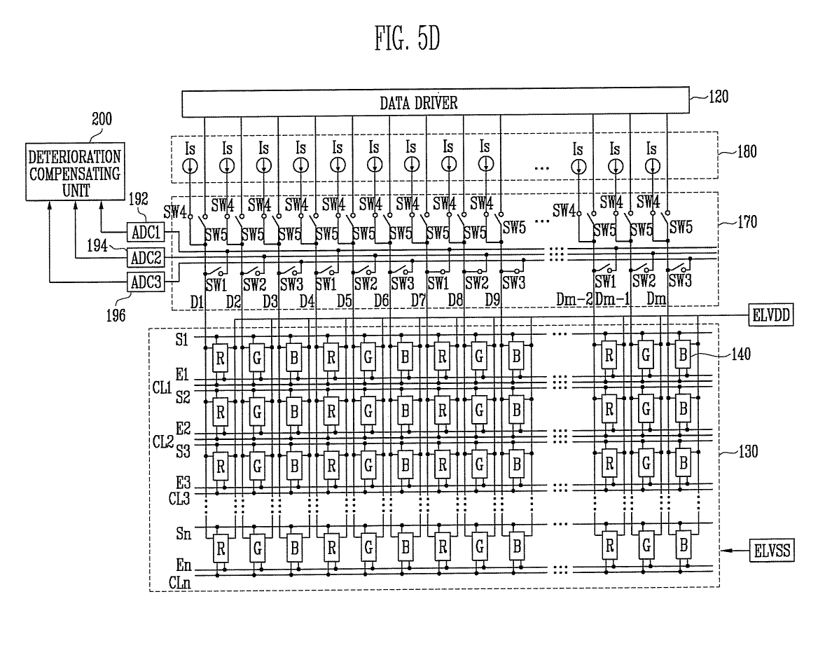

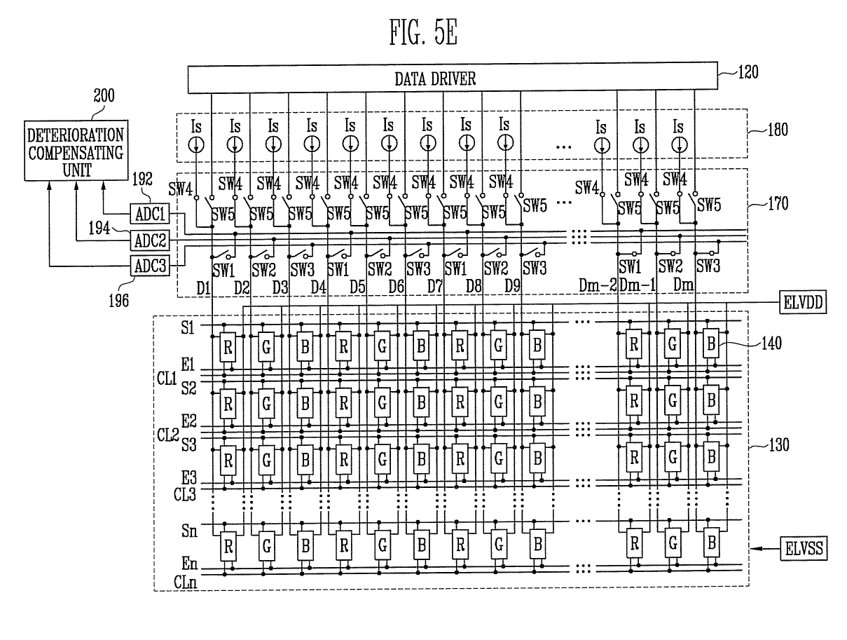

FIG. 4 illustrates waveforms illustrating the operation processes of the switches of FIG. 2. FIGS. 5A to 5E illustrate the operation processes of the switches corresponding to the waveforms of FIG. 4.

Referring to FIGS. 4 to 5E, operation processes will be described in detail. First, the control signals are sequentially supplied to the control lines CL1 to CLn in the sensing period. Then, in the sensing period, as illustrated in FIG. 5A, the fourth switches SW4 are maintained to be turned on.

First, when the control signal is supplied to the first control line CL1, the fourth transistor M4 included in the sub pixels 140 coupled to the first control line CL1 is turned on. Then, the current of the current sources Is is supplied to the OLEDs of the sub pixels 140 via the data lines D1 to Dm and the fourth transistor M4. At this time, a predetermined voltage corresponding to the deterioration is applied to the OLED.

In a period where the control signal is supplied to the first control line CL1, the first switches SW1, the second switches SW2, and the third switches SW3 are sequentially turned on in units of pixels. To be specific, the red sub pixels R, the green sub pixels G, and the blue sub pixels B constitute one pixel. Here, the first switches SW1, the second switches SW2, and the third switches SW3 are turned on in units of pixels to provide the voltage applied to the OLED to the ADCs 192, 194, and 196.

Actually, as illustrated in FIGS. 5B to 5E, the first switches SW1 are sequentially turned on. Then, the second switches SW2 and the third switches SW3 are sequentially turned on. Here, the switches SW1, SW2, and SW3 coupled to the sub pixels 140 that constitute the same pixel are simultaneously turned on to supply the voltage applied to the OLEDs of the sub pixels 140 to the ADCs 192,194, and 196. Then, the ADCs 192,194, and 196 convert the voltage supplied thereto into a digital signal to supply the digital signal to the deterioration compensating unit 200.

Then, the supply of the control signal to the first control line CL1 is stopped and the control signal is supplied to the second control line CL2. Then, as illustrated in FIGS. 5B to 5E, the first to third switches SW1 to SW3 are sequentially turned on to supply the voltage applied to the OLEDs of the sub pixels 140 coupled to the second control line CL2 to the ADCs 192, 194, and 196.

Actually, according to the present invention, in the sensing period, the control signals are sequentially supplied from the first control line CL1 to the nth control line CLn. Then, the switches SW1 to SW3 are sequentially turned on in units of pixels in periods where the control signals are supplied to supply the voltage corresponding to the deterioration of the sub pixels 140 to the ADCs 192, 194, and 196.

Then, the deterioration compensating unit 200 controls the timing controller 150 using the digital signal (deterioration information) supplied from the ADCs 192,194, and 196. Then, the timing controller 150 changes the bit value of the first data Data1 into the second data Data2 and supplies the generated second data Data2 to the data driver 120 to compensate for the deterioration. The data driver 120 generates the data signals using the second data Data2 in the driving period to supply the generated data signals to the data lines D1 to Dm. Therefore, in the driving period, the fifth switches SW5 are turned on.

As described above, according to the present invention, deterioration information on the sub pixels 140 can be provided to the deterioration compensating unit 200 while sharing the three ADCs 192, 194, and 196. On the other hand, according to the present invention, the number of ADCs 192, 194, and 196 can be at least one (smaller than the number of data lines). For example, when one ADC is provided, the first switches SW1, the second switches SW2, and the third switches SW3 are sequentially turned on (in units of sub pixels) to provide the deterioration information on the sub pixels 140 to the ADC.

In the organic light emitting display according to the present invention and the method of driving the same, the voltage applied to the OLEDs can be converted into the digital signal while sharing the ADC converter. Therefore, according to the present invention, manufacturing cost can be reduced and the volume of an integrated circuit (IC) is reduced to secure a degree of freedom of design.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display, comprising:
sub pixels positioned in the intersections between scan lines and data lines;
a current source unit supplying predetermined current to organic light emitting diodes (OLED) in a sensing period for grasping deterioration information on the OLEDs included in the sub pixels;
at least one analog-to-digital converter (ADC) provided fewer than data lines in order to convert a voltage applied to the OLEDs into a digital signal; and
a switching unit coupling the data lines to the current source unit in the sensing period and sequentially coupling at least one ADC to the data lines in the sensing period.

2. The organic light emitting display as claimed in claim 1, wherein at least one ADC comprises:
a first analog-to-digital converter (ADC) converting a voltage of OLEDs included in red sub pixels into a digital signal;
a second ADC converting a voltage of OLEDs included in green sub pixels into a digital signal; and
a third ADC converting a voltage of OLEDs included in blue sub pixels into a digital signal.

3. The organic light emitting display as claimed in claim 2, further comprising:
a deterioration compensating unit controlling digital signals supplied from the first to third ADCs so that deterioration of the OLEDs is compensated for;
a timing controller changing a bit value of data to compensate for the deterioration by the control of the deterioration compensating unit;
a data driver converting data supplied from the timing controller into data signals to supply the data signals to the data lines;
a scan driver supplying scan signals to the scan lines and supplying control signals to control lines that run parallel to the scan lines.

4. The organic light emitting display as claimed in claim 3, wherein the scan driver turns on transistors positioned between the data lines and the OLEDs in the sub pixels while sequentially supplying the control signals to the control lines in the sensing period.

5. The organic light emitting display as claimed in claim 4, further comprising:
fourth switches formed between the current source unit and the data lines;
fifth switches formed between the data driver and the data lines;
first switches positioned between the data lines coupled to the red sub pixels and the first ADC;
second switches positioned between the data lines coupled to the green sub pixels and the second ADC; and
third switches positioned between data lines coupled to the blue sub pixels and the third ADC.

6. The organic light emitting display as claimed in claim 5,
wherein the fourth switches are maintained to be turned on in the sensing period, and the fifth switches are maintained to be turned on in a driving period where an image is displayed on the sub pixels.

7. The organic light emitting display as claimed in claim 5, wherein the first switches, the second switches, and the third switches are sequentially turned on when the control signals are supplied.

8. The organic light emitting display as claimed in claim 7,
wherein the red sub pixels, the green sub pixels, and the blue sub pixels constitute a pixel, and
first switches, second switches, and third switches coupled to the same pixel are simultaneously turned on.

9. The organic light emitting display as claimed in claim 1, wherein the current source unit comprises at least one current source for supplying the current.

10. A method of driving an organic light emitting display, comprising:
supplying predetermined current to OLEDs included in sub pixels in units of horizontal lines in a sensing period;
converting a voltage applied to the OLEDs to correspond to the predetermined current into a digital signal while sharing at least one ADC;
changing a bit value of data to compensate for deterioration of the OLEDs corresponding to the digital signal; and
generating data signals using the data in a driving period and supplying the data signals to the sub pixels.

11. The method as claimed in claim 10, wherein the converting a voltage applied to the OLEDs to correspond to the predetermined current into a digital signal while sharing at least one ADC comprises generating the digital signals while sequentially coupling a first ADC to red sub pixels, a second ADC to green sub pixels, and a third ADC to blue sub pixels.

12. The method as claimed in claim 11,
wherein the red sub pixels, the green sub pixels, and the blue sub pixels constitute one pixel, and
the red sub pixels, the green sub pixels, and the blue sub pixels that constitute the same pixel are simultaneously coupled to the first ADC, the second ADC, and the third ADC.
